(19) United States
(12) Patent Application Publication
(10) Pub. No.: US 2009/0095735 A1
(43) Pub. Date: Apr. 16, 2009

(54) Flexible heating weave

(75) Inventor: Benjamin Resheff, Tel Aviv (IL)

Correspondence Address: THE NATH LAW GROUP, 112 South West Street, Alexandria, VA, 22314, US

(73) Assignee: THERMOSIV LTD., Ramat Gan (IL)

(21) Appl. No.: 11/990,711

(22) PCT Filed: Aug. 22, 2006
(86) PCT No.: PCT/IL2006/000975

§ 371 Date: Feb. 20, 2008

Related U.S. Application Data
(60) Provisional application No. 60/709,803, filed on Aug. 22, 2005.

(51) Int. Cl. H05B 3/34

(52) U.S. Cl. 219/549; 219/545; 219/507

(57) ABSTRACT

A novel electrical resistance heating weave (10) is disclosed. By one embodiment both warp threads (12) and weft threads (14) are electrically-conductive, thereby establishing a heating weave with an increased capacity for heat dissipation. Also disclosed are configurations (900, 1000) for adjusting the base heat dissipation of the weave via cuts and slits (902, 1002. 1004) in the weave, and conductive electrical feed strips (104, 106, 110, 112, 120, 122) in various configurations for powering bi-directional power and for trimming adjustment to compensate for minor variations in thread resistance.

### FIELD OF THE INVENTION

The present invention relates to flexible electrical heating devices, and, more particularly, to the design and configuration of a versatile and flexible conductive weave that can act as a heater.

### BACKGROUND OF THE INVENTION

Flexible woven heaters are applied in clothing, bedding, and upholstered furniture for buildings and vehicles, for direct heating of the body. Additional uses are in process-control equipment and for warming temperature-sensitive items.

Some relevant prior-art literature includes:

U.S. Pat. No. 6,875,963 to Rock, et al. (herein denoted as “Rock '963”), entitled “Electric heating/warming fabric articles”, describes electric heating/warming composite fabric articles that have at least a fabric layer with inner and outer surfaces, and an electric heating/warming element in the form of a flexible electrically-conductive film disposed at the inner surface of the fabric layer and adapted to generate heat when connected to an electrical power source. The configuration of electrical elements within a heating fabric, such as disclosed in Rock '963, is known to be limited by safety considerations, because the heating temperature in the vicinity of the fabric cannot be allowed to exceed certain effective temperatures. Another limitation in this type of heating fabric is that the flexibility of the fabric becomes limited due to the engagement of the heating elements.

The development of electro-conductive polymers that can be manufactured in the shape of threads brought about many advantages because such threads can be incorporated in the weaving of a fabric that can act as a flexible heater. Russian Patent 2,155,461 to Ofitserjan and Skiba (herein denoted as “Ofitserjan”), entitled “Flexible heating element”, describes a conductive fabric that contains insulated resistive layers formed from complex electro-conductive threads, situated perpendicularly to electrodes in the margins of the fabric. Ofitserjan also discloses a zone in which there are additional electrodes intersecting with the marginal electrodes, situated perpendicularly thereto, and parallel to the complex electro-conductive polymer threads.

Subsequent to the issuing of Ofitserjan, a similar disclosure was filed in the United States, in U.S. Pat. No. 6,649,886 to Kleshchik (herein denoted as “Kleshchik”), entitled “Electric heater cloth and method”. As in Ofitserjan, Kleshchik describes a heating fabric composed of conductive resistive threads which are interwoven with non conductive threads.

The arrangement of the conductive threads within the fabric as described in Ofitserjan and Kleshchik restricts the ability of the fabric to be used in many applications. For example, by limiting the conductive threads to be arranged solely in one direction, the full heating potential of the weave is not utilized, because about half the threads in the fabric are non-conductive. Moreover, as shown in Kleshchik, due to the arrangement of conducting bus bars and perpendicular distributing bus bars and dielectric zones, circuit breakers in the shape of holes in the fabric are provided, which further limits the use of the fabric as constructed.

Some additional prior art includes the following:

U.S. Pat. No. 6,944,393 to Stabile (herein denoted as “Stabile”), entitled “Panel made of a highly insulated electro-thermal fabric”, describes a panel for generating and diffusing heat obtained from a heat-radiating board comprising one or more pieces of electro-thermal fabric, with strips of fiberglass laid side by side to form a warp, the weft being a continuous copper wire.

US Application 2004/0238527 by Ozawa, et al. (herein denoted as “Ozawa”), entitled “Flexible Heating Sheet”, describes a flexible heating sheet composed of two heat fusible aromatic polyimide films and an electric source-connecting terminal at each end which intervenes between the heat fusible aromatic polyimide films, in which each heat fusible aromatic polyimide film is covered with a heat resistant aromatic polyimide film.

US Application 2005/0061802 of Rock (herein denoted as “Rock '802”), entitled “Electric Heating/Warming Fabric Articles”, describes a fabric article that generates heat upon application of electrical power, which is made, for example, by knitting or weaving to form a fabric pre-body, such as in the knit-welt or tuck-welt configuration, wherein the electrical resistance heating elements extend between opposite edge regions of the fabric. Rock '802 provides conductive elements for connecting the electrical resistance heating elements to a source of electrical power.

As previously noted, the configuration provided by Ofitserjan and by Kleshchik is limited in practice to rectangular shapes—non-rectangular shapes having non-uniform and potentially dangerous heating behavior. Thus, there remains a need for a flexible, versatile, and reliable heating fabric that utilizes substantially all the threads for heating, as well as a need for methods of controlling the intrinsic heat output characteristics of the fabric. These goals are met by the present invention.

### SUMMARY OF THE INVENTION

The present invention provides a novel heating fabric. The novel heating fabric according to some embodiments of the invention is flexible, reliable and versatile.

Also provided by the present invention is a heating device that is flexible and can be used in a wide spectrum of applications, including, but not limited to: heating fabrics for the textile industry; heating devices for seats and other furniture in buildings as well as in vehicles; space heating devices for rooms that are concealed within furniture and ornamental/decorative objects; and heating devices for items that need to be maintained at a constant temperature.

Therefore, according to the present invention there is provided a flexible, versatile, and reliable electrical heating weave including: (a) a warp having at least one warp thread, preferably a plurality of such threads, which are electrically conductive resistive threads, typically threads coated with an electrically conductive resistive material; (b) a weft interwoven with the warp, wherein the weft has at least one weft thread, preferably a plurality of such threads, which are electrically conductive resistive threads, typically threads coated with an electrically conductive resistive material; (c) electricity feed elements that can be linked to a source of electric power and which are configured to provide, once linked to such source, electrical power to the at least one warp thread and the at least one weft thread.

The warp and the weft are preferably configured to radiate heat in a homogeneous manner.

The electric feed elements are, according to an embodiment of the invention, integral feed strips made of conductive material in electrical contact with said at least one warp thread and said at least one weft thread.

At times all the warp threads or the weft threads are electrically conductive resistive threads; at times a portion of the threads may be electrically conductive resistive threads and the other portion consisting of electricity non-conductive threads, such as conventional textile threads.

In addition, according to the present invention there is also provided an electrical heating fabric comprising: two or more segments each of which comprises a first group of threads in a first direction and a second group of threads in a second direction perpendicular to the first, at least some of the first group or of the second group of threads being electrically conductive; the two or more segments being electrically connected to one another through one or more connecting electrically conductive elements, each one or more of the electrically conductive elements electrically connecting two segments; two of the segments comprising and electricity feed element connected to a sources of electricity; the different segments, the electrically conductive elements and the feed elements being configured such so that electric current flows in series through two or more segments.

Moreover, according to the present invention there is provided, in an electrical heating fabric, an arrangement of electrical feed strips for enabling adjustment to compensate for manufacturing variations in the fabric, the arrangement including a plurality of sets of electrical feed strips, wherein at least one of the sets includes at least two electrical feed strips which are substantially parallel and which are separated by a predetermined distance that is substantially less than the distance between the sets.

### BRIEF DESCRIPTION OF THE DRAWINGS

The invention is herein described, by way of example only, with reference to the accompanying simplified mechanical drawings, wherein:

FIG. 1 is an illustration of a portion of a flexible heating weave in accordance with an embodiment of the present invention.

FIG. 2A is an illustration of a flexible heating weave with conductive electrical feed strips for connection to an electrical power source, in accordance with an embodiment of the present invention.

FIG. 2B is an illustration of a flexible heating weave with bidirectional conductive electrical feed strips for connection to an electrical power source, in accordance with another embodiment of the present invention.

FIG. 2C is an illustration of a flexible heating weave with conductive electrical feed strips in a minimal configuration for trimming adjustment, in accordance with yet a further embodiment of the present invention.

FIG. 2D is an illustration of the flexible heating weave of FIG. 2C with an additional electrical feed strip for fine trimming adjustment.

FIGS. 3A and 3B are schematic side cross-sectional views of protected flexible heating weaves in accordance with embodiments of the present invention.

FIG. 4 is a side cross sectional view of a heating weave having an area with increased heat dissipation in accordance with an embodiment of the present invention.

FIG. 5 is a cross-sectional view of a flexible heating weave in accordance with an embodiment of the present invention.

FIG. 6 is a cross sectional view of a conductive thread incorporated within a heating weave in accordance with an embodiment of the present invention.

FIG. 7 is a simplified illustration of the construction of a prior art electric heating fabric.

FIG. 8 is a simplified illustration of the flow of electrical current in the prior art electric heating fabric of FIG. 7.

FIG. 9 is a simplified illustration of a two-segment electrical heating fabric having a cut according to an embodiment of the present invention.

FIG. 10 is a simplified illustration of a three-segment electrical heating fabric having two cuts according to an embodiment of the present invention.

### DESCRIPTION OF THE PREFERRED EMBODIMENTS

The principles and operation of a flexible heating weave according to embodiments of the present invention may be understood with reference to the drawings and the accompanying description.

### Bi-Directional Conductive Weave

The present invention provides a unique and novel flexible heating device that can be used in many applications due to its versatility in shape as well as in electrical characteristics. A heating weave according to a preferred embodiment of the present invention is a bi-directional weave comprising electrically conductive resistive threads, typically threads coated by a material imparting such properties. For example, in order to render them electrically conductive resistive threads, regular textile threads may be coated by electro-conductive polymers. The term “electrically conductive resistive threads” denotes that the threads although being conductive, the conductivity is relatively low, substantially less than that of a good conductor such as metal.

The basic weave comprises electrically conductive warp threads as well as electrically conductive weft threads. The bi-directionality of the electrically conductive threads enables the weave to achieve a higher density of heating output than a weave with uni-directional electrically conductive threads.

The polymeric threads according to a preferred embodiment of the present invention have a relatively high thermal stability, and are made of an electrically-non-conductive central core surrounded by an electrically conductive resistive shell.

The term “conventional thread” herein denotes any electrically-insulating (non-conductive) thread or yarn that may be of a kind used in weaving or knitting of fabrics employed in items including, but not limited to: clothing, hosiery, accessories, and undergarments; upholstery; bedding materials; luggage and the like; and curtains and wall-coverings. Typical conventional thread materials include, but are not limited to: cotton, linen, jute, hemp, and other vegetable fibers; wool and other animal hair; nylon, rayon, Dacron, acrylic, polyester, polyethylene, and other synthetics; and glass fiber.

The term “weave” herein denotes a fabric that is produced by a weaving process. The term “fabric” herein denotes a textile material which is produced from fibers by any suitable process, including, but not limited to: weaving, knitting, crocheting, and felting. The term “cloth” is often used as a synonym of “fabric”. It is understood that a material identified as a “weave” may also be identified as a “fabric” to illustrate the application of an embodiment of the present invention to a more general class of textiles.

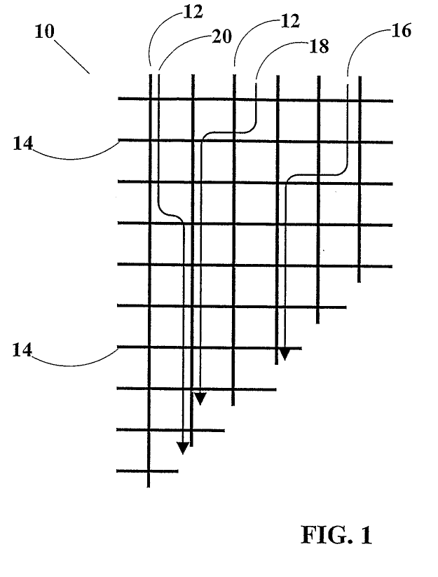

Reference is now made to FIG. 1, which is an illustration of a portion of a flexible heating weave 10 in accordance with an embodiment of the present invention. Weave 10 has warp threads 12 and weft threads 14. At least some and at times all warp threads 12 and weft threads 14 are made of a conductive material, as will be elaborated below. Warp threads and weft threads are thus electrically linked to one another through the nodes where they cross one another. The flow of electricity is determined by the respective resistances of the various possible paths and as a result complex electricity flow patterns may arise, such as those illustrated schematically by arrows 16, 18 and 20. In consequence there are many parallel paths of substantially the same electrical resistance in the weave and thus once induced to flow (see below regarding electrical feed) the electric current will propagate in relative uniformity (as compared to a weave where threads in only one direction are conductive)t the weave and consequently the heat dissipation throughout the weave will not differ substantially from one region or another.

In prior-art heating weaves the electrically conductive threads are in one direction in the heating fabric, each thread has an electrical resistance proportional to the thread's length. For a constant voltage power source, the heat dissipated by a length of resistive thread is inversely proportional to the thread's electrical resistance. Thus, for a constant voltage power source, a short thread dissipates more heat than a long thread. Typically, electrical power sources for heating devices are voltage sources. Therefore, uniformity of heat radiation in a non-rectangular cut prior-art heating fabric is impossible—short threads resulting from the irregular cut will dissipate large amounts of heat and may create potentially-dangerous “hot spots”.

In embodiments of the present invention, however, both warp and weft threads are electrically conductive. One advantage of this arrangement is that a given area of the weave according to such embodiments has significantly increased heating capacity over the same area of a prior art weave.

### Electrical Power Input

The electricity feed element is typically made of a conductive material such as metal which is preferably made to be integral with the weave. The term “intergral” denotes that the strip is integrated into the fabric through weaving, knitting, embroidery, stitching, sewing, adhering and in general or in any other manner that will make such strip to be an inseparable element of the weave. The feed strips may be made of or comprise metallic wires. Such wires may be incorporated into the weave as warps or wefts or may be incorporated as embroidery. According to another embodiment such a feed strip is a metal foil attached, stitched or sewn or firmly adhered to the weave. The feed strip is connected, through means known per se, to a mains or another source of electric power.

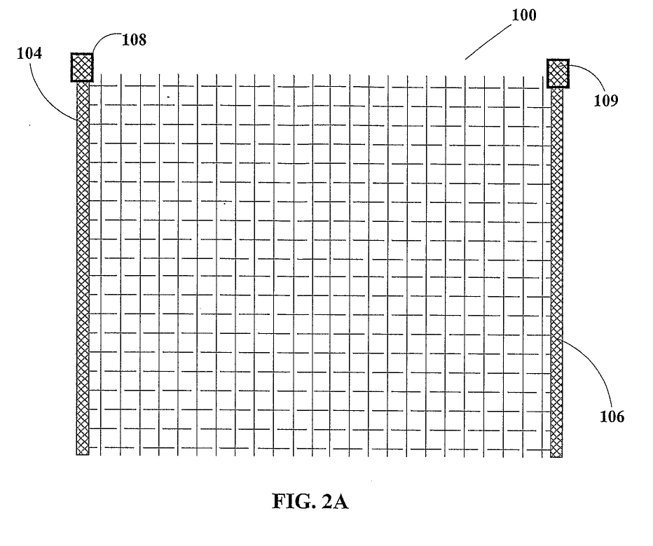

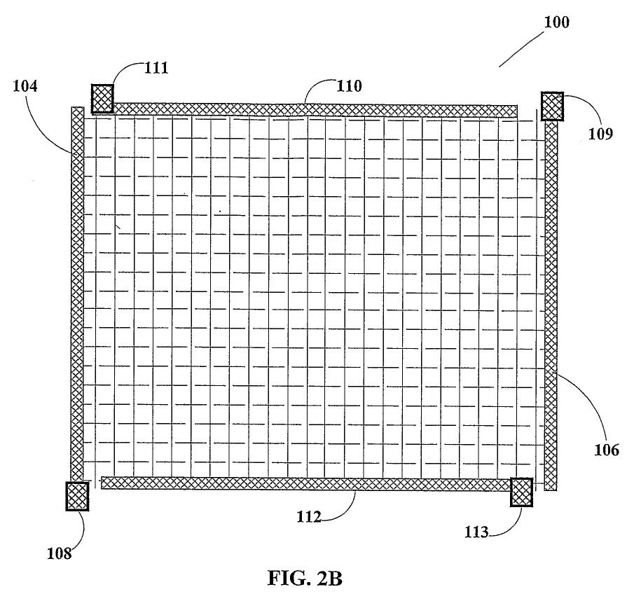

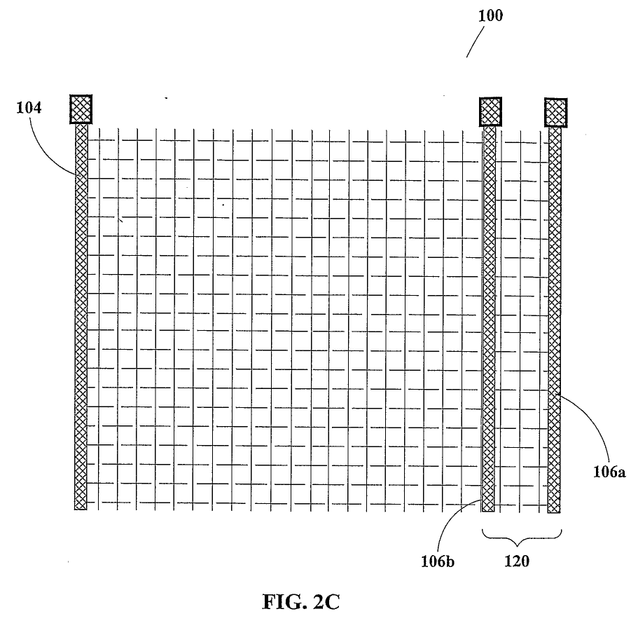

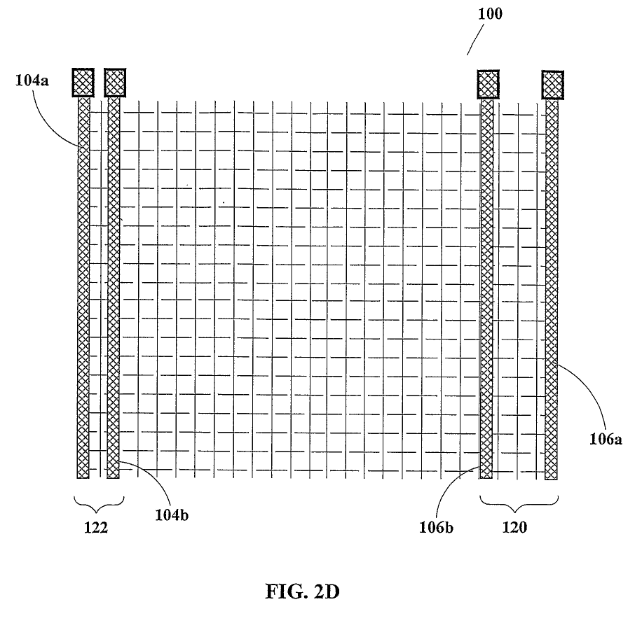

Reference is now made to FIG. 2A which is an illustration of a flexible heating weave 100 in accordance with an embodiment of the present invention, having electrically conductive warp and weft threads similar to weave 10 (FIG. 1). Weave 100 includes an electrical power feed strip 104 and a feed strip 106 located at opposite sides of weave 100 with a predetermined distance in between. The distance between the feed strips is determined by the electrical characteristics of the power source and the desired heat dissipating capacity. In practice, it is typically a voltage source which is applied between feed strip 104 and feed strip 106.

Feed strips 104 and 106 are made of a highly conductive, typically flexible material. In a non-limiting embodiment of the present invention, the feed strips are made of a thin metallic ribbon wound around a fiber core, and are woven into the flexible heating weave. In another non-limiting embodiment of the present invention, the feed strips are made of flexible multi-stranded metallic wires that are attached to the flexible heating weave. In yet a further non-limiting embodiment of the present invention, the feed strips are made of thin metallic ribbon that is applied to the flexible heating weave in the manner of embroidery. In yet a still further embodiment of the invention the feed strips are made of a thin metallic foil attached to the weave.

Provisions for electrical connection to the feed strips may also be made in a variety of ways. In a non-limiting embodiment of the present invention, a tab-terminal metal electrical connector 108 and 109 are attached to feed strip 104 and 106, respectively to allow weave 100 to be electrically connected to a power source, such as an electrical main, a battery, etc. Connectors 108 and 109 may be the same or different. In another non-limiting embodiment of the present invention, a jack configuration is used for connectors 108 and 109. In an additional non-limiting embodiment of the present invention, a snapper-type metal electrical connector is used for connectors 108 and 109. In yet a further non-limiting embodiment of the present invention, a portion of the feed strips themselves extend from the flexible weave, and can be encased in suitable insulators and joined together to form a power cord, to which any suitable connector can be attached.

The feed strips can be oriented in the warp direction as well as in the weft direction. Additionally, it is also possible in some embodiments of the present invention, for example in the case of a feed strip in the form of a metal foil attached to the weave, for the feed strip to assume an orientation in between the weft and the warp orientation.

FIG. 2B shows another embodiment of the present invention, wherein additional feed strips 110 and 112 are provided, with their respective connectors 111 and 113, in a substantially perpendicular direction to feed strips 104 and 106. As in FIG. 2A, electrical power is applied between feed strip 104 and feed strip 106. In addition, however, electrical power may also be applied, simultaneously or in an alternate fashion between feed strip 110 and feed strip 112.

### Adjusting Heat Output to Compensate for Manufacturing Variations

Minor variations in manufacturing processes may result in the production of portions or materials which have properties that vary statistically from one run to the next. In particular for the present case, it is to be expected that there may be minor statistical variations in the specific resistance of the electrically-conductive threads used in the weave. Thus, for a given voltage applied across the feed strips there may be minor variations in heat output from one piece of heating fabric to another. Embodiments of the present invention therefore provide means for making minor adjustments to correct for these variations, not only in heating weaves but in heating fabrics of other kinds as well.

In this way, the present invention improves the reliability of the heating weave by bringing the consistency of the effective resistance of the weave to a higher level. As is discussed below, embodiments of the present invention provide for calibrating the effective resistance of the heating weave in a precise manner. The heat output of the heating weave is therefore more accurately set, thereby improving the reliability of the heating weave to perform a given function.

According to an embodiment of the present invention, a set of feed strips may be provided in a region of the weave rather than a single one. This set of feed strips may include a plurality of substantially parallel feed strips which are oriented in the same direction and which are spaced according to a predetermined spacing scheme.

FIG. 2C illustrates this embodiment of the present invention having a non-limiting minimal configuration for resistance adjustment, whereby electrical feed strip 106 of FIG. 2B is replaced by a set 120 of feed strips 106a and 106b, which are substantially parallel and separated by a predetermined distance. The configuration illustrated in FIG. 2C allows for a “trimming” adjustment of the heat output of heating fabric 100 for a given electrical power source.

The feed strips can be selectively connected to an electrical power source for precisely adjusting the resistance value of the weave. The heating fabric can be calibrated and a table of resistance values and corresponding external connections can be provided. Depending on the desired heat dissipation or on the specific resistance of the fabric, a choice may be made between use of strip 106a and 106b. This may be in a manual fashion, selectable by a user or, by some embodiments, automatic. As will be appreciated, in some embodiments of the invention a set of feed strips may comprise three or more feeds strips, rather than two.

Typically, the distance separating the feed strips within a set of feed strips is substantially less than the distance between the sets of feed strips. Thus, the electrical resistance between feed strips within a set is substantially less than the electrical resistance between the sets of feed strips. The result is that changing the selected feed strip within a set makes only a relatively small change in the effective resistance of the heating fabric. This small change, however, is sufficient for the purpose of fine-tuning or the minor adjustment needed to compensate for manufacturing variations in the electrical resistance of the conductive threads. The term “effective resistance” herein denotes the resistance of a heating fabric as seen by the electrical source which powers the heating fabric.

For example, with reference to FIG. 2C, the effective resistance of heating fabric 100 may be adjusted by connecting feed strip 104 to one terminal of an electrical power source, and a feed strip selected from set 120 to the other terminal of the power source. The effective resistance of fabric 100 is determined by which feed strip is selected from set 120 for connection. If feed strip 106a is selected, the effective resistance will be higher than if feed strip 106b is selected. In an embodiment of the present invention, the selection can be accomplished by connecting feed strip 106a to the other terminal of the power source and selectively utilizing or not utilizing a short conductive jumper from feed strip 106a to feed strip 106b. Suitable jumpers include, but are not limited to: a wire, an electrically conductive tab, and a drop of solder. In the case of a wire jumper, in an embodiment of the present invention, the feed strips of a set are manufactured with a connecting jumper wire, and the trimming adjustment is made by either cutting or not cutting the jumper wire. Connecting feed strip 106a to the appropriate terminal of the electrical power source will result in the maximum effective resistance for heating fabric 100, whereas connecting feed strip 106b to the appropriate terminal of the electrical power source will result in the minimum effective resistance for heating fabric 100.

The configuration illustrated in FIG. 2C is a minimal configuration for this embodiment of the present invention because there is only one set of feed strips that includes more than one element (set 120), and set 120 includes only two feed strips. Another configuration illustrated in FIG. 2D has an additional set 122 of feed strips in place of feed strip 104 (FIG. 2C), containing a feed strip 104a and a feed strip 104b. In this embodiment the predetermined distance and hence the electrical resistance between feed strip 104a and feed strip 104b is less than that between feed strip 106a and feed strip 106b. Thus, selecting between connecting feed strip 106a and feed strip 106b results in a relatively coarse adjustment in the effective resistance of heating fabric 100, whereas selecting between connecting feed strip 104a and feed strip 104b results in a relatively fine adjustment in the effective resistance.

Other configurations are possible, including sets of electrical feed strips containing more than two feed strips, as well as different schemes in the predetermined spacing.

### Weaving, Knitting, and Other Attachment Methods

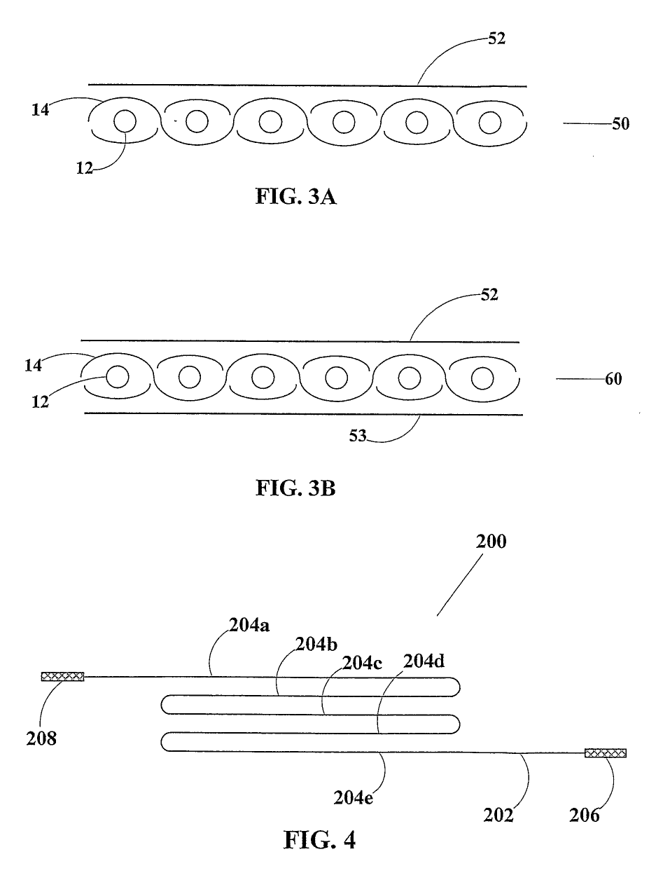

In a preferred embodiment of the present invention, the weft threads are interwoven with the warp threads (as shown in FIG. 3). In other embodiments of the present invention, substantially perpendicular threads may be held together via other means, including, but not limited to: knitting; laminating; adhesion; and mechanical joining.

### Protective Covering

Reference is now made to FIGS. 3A and 3B, which illustrates cross-sectional views of protected flexible heating weaves in accordance with embodiments of the present invention. A weave 50 is basically similar to weave 10; it has electrically conductive warp threads 12 and electrically conductive weft threads 14. Conductive threads, in high temperature conditions can go through an oxidation and degradation process that can damage the conductive shell of the thread. Moreover, a danger of electrocution from exposed conductive elements exists in an exposed weave. Therefore, a cover 52 covering one face of the weave in the case of the embodiment of FIG. 3A and covers 53 and 54 covering both faces of the weave in the case of the embodiment f FIG. 3B may be provided to ensure a safe operation of the electric flexible weave of the present invention. Weave 50 can stand in highly humid conditions and depending on the nature of the coating may even be immersed in liquid, e.g. water, during operation. Cover 52 and/or 53, in addition to protecting the weave from exposure to environmental hazards such as humidity, and harsh physical conditions, and can also impart mechanical strength and flexibility and ensure the integrity of operation throughout.

Cover 52 or 53 is preferably made of fire-resistant and thermally-durable material that is elastic; such materials include, but are not limited to, a polymeric elastomer such as polymeric resin, silicone elastomer, polyurethane, or butylic rubber. The formation of the cover and its adhesion onto the weave can be accomplished by laminating the flexible material onto the weave. Other coating mechanisms are used in other embodiments of the present invention.

### Folding to Increase Heat Dissipation Density

In order to increase the heat dissipation of the weave for a given surface area, it is possible, according to some embodiments of the invention, to fold the weave such that two or more portion thereof overlap. In this way, the heating density in said surface area is markedly increased without a need to increase the voltage.

Reference is now made to FIG. 4, which is a cross-sectional view of a heating weave having a region with overlapping portions to giving rise to a region with increased dissipated heat density in accordance with an embodiment of the present invention. A weave 200 is folded such as to yield a region 202 that is multi-layered formed by overlapping weave portions, five—204a, 204b, 204c, 204d and 204e, in this embodiment, for generating increased heat relative to a region, such as region 202, having only a single layer. The extent and positioning of the multilayer region can be adjusted to suit the application and specific usage of the weave. An electrical connector 206 and 208 that are linked to corresponding feed strips (not shown) provide power to weave 200.

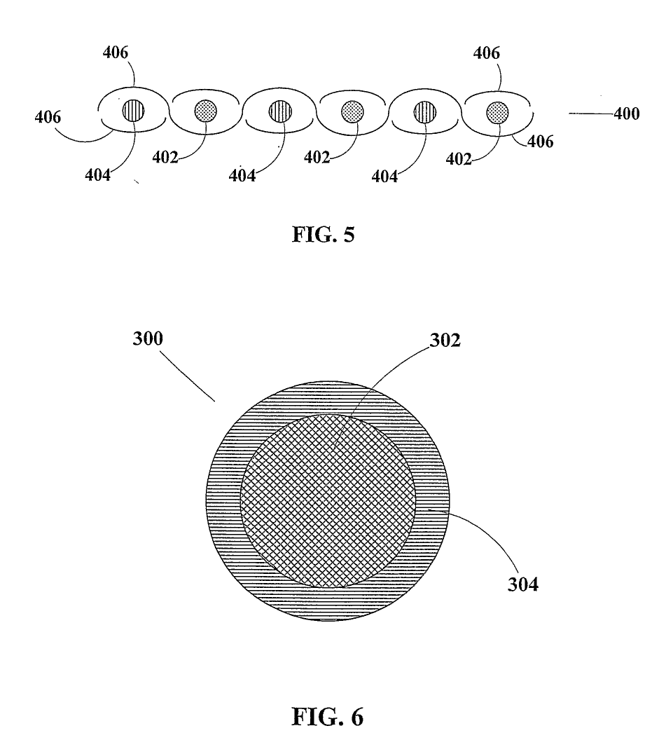

Reference is now made to FIG. 5, which is a cross sectional view of a conductive weave in accordance with embodiments of the present invention. Weave 400 comprises warp threads of two different kinds 402 and 404, for example one 402 being an electrically conductive thread (e.g. with a non-conductive core and a conductive resistive coating) in this specific embodiment and the other being a conventional textile thread. The ratio between conductive and non-conductive may of course also be other than 1:1. In some embodiments the different warp threads may be threads with different electric conductive properties. In certain embodiments of the present invention, weave 400 is provided with different kinds of warp threads. Many conventional textile or electrically conductive threads can be incorporated in the warp or in the weft.

Reference is now made to FIG. 6, which is a schematic cross sectional view of a conductive thread incorporated within the heating weave in accordance with an embodiment of the present invention. A thread 300 comprises a core 302 and a shell 304. Core 302 imparts the tensile strength to the thread and shell 304 may be an electrically conductive polymeric or other conductive material, which is preferably selected to have a high adhesiveness to core 302, in order to withstand the friction encountered in the weaving process as well as to withstand normal abrasion encountered during use of the woven fabric. Core 302 can be made from a durable material that can withstand the heat and physical conditions encountered during use. Shell 304 can, for example, be made of vitton, which can endure temperatures up to 250 degrees Celsius. Vitton has relatively high polarity and can be cured to attain an even higher thermal durability.

Another family of materials that can be used as the matrix of shell 304 are the cyano-resin based materials. Those materials can also provide a shell having relatively high thermal tolerance.

A highly adhesive, high-conductivity carbon, a non-limiting example of which is acetylenic carbon, such as manufactured by Cabot or Degusa, can be embedded within the matrix of an elastomeric polymer. This high-conductivity carbon can provide better results than those achieved by prior art carbon fillers, and can do so with less carbon in the matrix.

### Configuring for a Heat Output Range

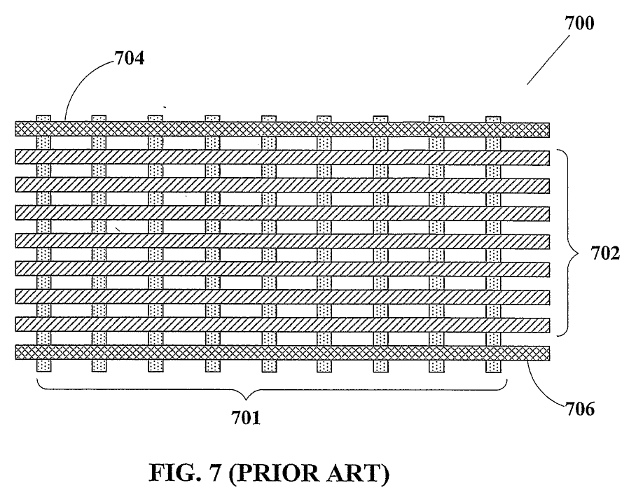

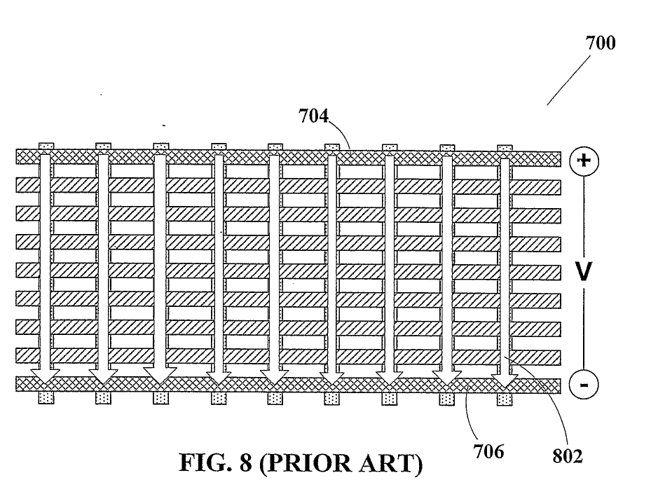

FIG. 7 is an illustration of a prior art heating fabric 700 having a group of non-conductive threads 702 extending in a first direction, and a group of conductive threads 701 extending in a second, perpendicular direction. Electrical feed strips 704 and 706 provide electrical power to electrically conductive threads 701. FIG. 8 illustrates current flow 802 in this prior art heating fabric 700, when an electrical voltage source is connected to electrical feeder strips 704 and 706, with at shown polarity induces flow of current as represented by arrows 802.

For a given input voltage, the heat output of prior art heating fabric 700 is determined by the resistance of electrically conductive threads 701, the number of electrically conductive threads, and the geometrical characteristics of the fabric. Thus, the only ways of adjusting the heat output of such prior-art heating fabric are:
to adjust the input voltage;
to adjust the fabric geometry; and
to apply a duty cycle to the input electrical power.

Adjusting the geometry of the heating fabric is generally not possible as it is dictated by the use requirements, and changing input voltage, while possible, is often impractical. Typically, therefore, a common prior-art technique is to apply a duty cycle to the input electrical power in order to control heat output.

The present invention, in accordance with some of its embodiments provides means of configuring a heating fabric to establish a base heat dissipation without altering input voltage or the heating fabric geometry.

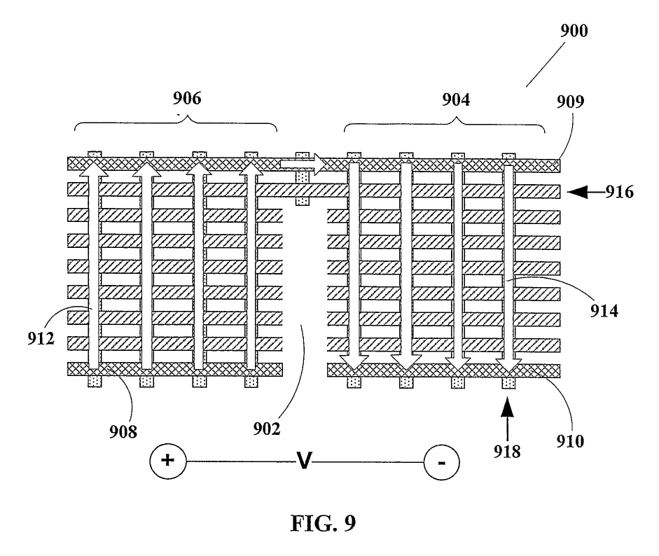

FIG. 9 is an illustration of an embodiment of the present invention which provides for the configuration of an electric heating fabric 900 to have a selectable heat output for a given input voltage. The configuration is performed by segmenting heating fabric 900 via a cut 902, into a segment 904 and a segment 906.

According to an embodiment of the present invention, each segment features a first group of threads arranged in a first direction represented by arrow 916 and a second group of threads arranged in a second direction represented by arrow 918 which is substantially perpendicular to first direction 916. The second group of threads (in direction 918) is electrically conductive, and in certain embodiments of the present invention, the first group of threads (in direction 916) is also electrically conductive. An electrically conductive feed strip 908 in segment 906 and an electrically conductive feed strip 910 in segment 904 are arranged in first direction 916 and are in electrical contact with both the second group of electrically conductive threads (in direction 918) and also with a source of electrical power. In an embodiment of the present invention, feed strip 910 and feed strip 908 are derived from a single feed strip that existed prior to the making of cut 902. In addition, an electrically conductive strip 909 at the opposite direction of fabric 900 electrically connects segment 904 to segment 906, but is not directly connected to a source of electrical power.

Upon the application of a positive voltage to feed strip 908 and a negative voltage to feed strip 910 as shown in FIG. 9, current will flow in segment 906 from feed strip 908 to strip 909 in a direction of arrow 912. Current will then flow into segment 904 through strip 909, and from thence in a direction of arrow 914 to feed strip 910, which is at negative potential.

Resistive heat dissipation for a voltage source is given by V²/R, where V is the applied voltage and R is the resistance. It is also seen that the novel configuration of fabric 900 in FIG. 9 has a resistance which is about four fold that of a fabric of the same dimensions having the prior art configuration as seen in FIG. 8. Consequently, the novel configuration of fabric 900 (FIG. 9) dissipates about ¼ of the heat of the corresponding prior art configuration of fabric 700 (FIG. 8) for an identical voltage and fabric geometry.

In an embodiment of the present invention, cut 902 severs the feed strip into feed strip 908 and feed strip 910, and removes threads in direction 918, but does not sever threads in direction 916, thereby retaining the mechanical strength of the threads in direction 916. Cut 902 may also be configured as a narrow slit.

In an embodiment of the present invention, cut 902 extends along direction 918 over at least substantially 60 percent of the fabric dimension in that direction.

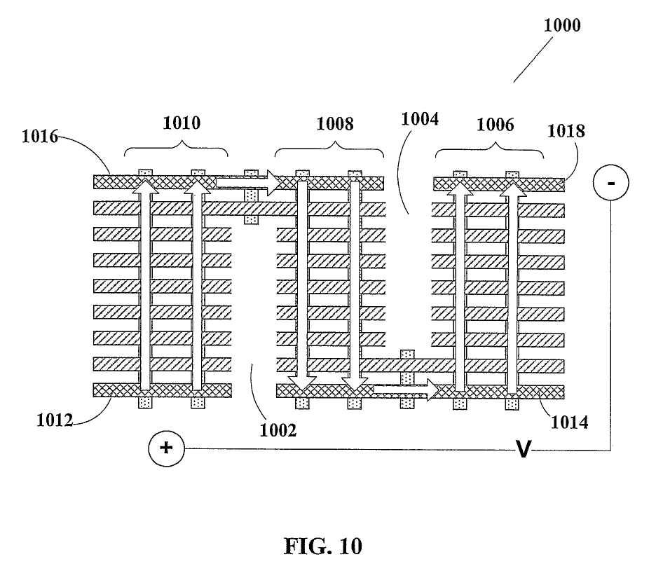

FIG. 10 illustrates another embodiment of the present invention, whereby a heating fabric 1000 is given a configuration involving a first cut or slit 1002 and a second cut or slit 1004, thereby dividing fabric 1000 into three segments—a segment 1006, a segment 1008, and a segment 1010. Once again, there are two feed strips connected directly to a source of electrical power: a feed strip 1012 at a positive potential, and a feed strip 1018 at a negative potential. In addition, there are two strips which are not connected directly to electrical power: a strip 1014 and a strip 1016 which electrically link segments 1006 and 1008 and segments 1009 and 1010, respectively. The electrical analysis of fabric 1000 is similar to that of fabric 900 (FIG. 9), and it is seen that the resistance R of fabric 1000 in the novel configuration of FIG. 9 is approximately 9 times that of the prior art configuration of fabric 700 in FIG. 8, and therefore dissipates approximately 1/9 as much heat.

Other configurations of cuts with different base heat dissipations are featured in various other embodiments of the present invention.

In some embodiments of the invention the fabric, such as fabric 900 or 1000 described above, comprises electrically conductive fibers in both perpendicular directions to yield uniform electric flow through each segment in a similar manner to that described in FIG. 1, above.

### APPLICATIONS

Products made from and/or featuring a flexible heating weave according to embodiments of the present invention include, but are not limited to: bedding materials; items of clothing, such as thermal body suits, thermal underwear, thermal outerwear, gloves, hosiery, scarves, shawls, headwear, footwear, and protective apparel; room heating appliance; furniture, upholstery, and the like; vehicle seats; process control equipment; protective gear; incubators, and other warming devices; aero-space equipment; de-icing apparatus.

While the invention has been described with respect to a limited number of embodiments, it will be appreciated that many variations, modifications and other applications of the invention may be made.

1-40. (canceled)

41. An electrical heating weave comprising:
a warp having at least one warp thread coated with an electrically conductive resistive material;
a weft interwoven with said warp, wherein said weft has at least one weft thread coated with an electrically-conductive resistive material;
electricity feed elements that can be linked to a source of electric power and which are configured to provide, once linked to such source, electrical power to the at least one warp thread and the at least one weft thread.

42. The heating weave of claim 41, configured so that said warp and said weft radiate heat in a homogeneous manner.

43. The heating weave of claim 41, wherein said electricity feed elements are integral feed strips made of conductive material in electrical contact with said at least one warp thread and said at least one weft thread.

44. The heating weave of claim 43, further comprising an arrangement of said electrical feed strips including a plurality of sets of said electrical feed strips, wherein at least one of said sets includes at least two electrical feed strips which are substantially parallel and which are separated by a predetermined distance that is substantially less than the distance between said sets.

45. The heating weave of claim 44, wherein at least two of said sets include at least two electrical feed strips which are substantially parallel and which are separated according to predetermined schemes.

46. The heating weave of claim 44, wherein at least one of said sets includes more than two electrical feed strips which are substantially parallel and which are separated according to a predetermined scheme.

47. The heating weave of claim 43, wherein at least one of said feed strips is selected from the group consisting of a metallic ribbon wound around a fiber core or a metallic wire.

48. The heating weave of claim 43, wherein a feed strip is incorporated into at least one of said warp and said weft in the manner of embroidery.

49. The heating weave of claim 43, wherein said at least two feed strips are configured in said warp direction, in said weft direction or in both directions.

50. The heating weave of claim 41, wherein said warp or said weft contains at least one conventional thread.

51. The heating weave of claim 43, further comprising at least two segments which are at least partially separated by at least one cut in at least in one feed strip.

52. The heating weave of claim 51, wherein an electrical feed strip of a segment extends to another segment or is in direct electrical contact with a feed strip of another segment.

53. The heating weave of claim 51, wherein said at least one cut is a slit, said slit has a length extending in the heating weave along substantially at least 60 percent of the length of the segment in the direction of said slit.

54. An electrical heating fabric comprising:
two or more segments each of which comprises a first group of threads in a first direction and a second group of threads in a second direction perpendicular to the first, at least some of the first group or of the second group of threads being electrically conductive; the two or more segments being electrically connected to one another through one or more connecting electrically conductive elements, each one or more of the electrically conductive elements electrically connecting two segments; two of the segments comprising and electricity feed element connected to a sources of electricity; the different segments, the electrically conductive elements and the feed elements being configured such so that electric current flows in series through two or more segments.

55. The heating weave of claim 54, wherein the different segments are defined by cuts in the fabric.

56. The heating fabric of claim 55, wherein said cut is a slit made along one of said first or said second direction and has a length extending in the heating fabric along substantially at least 60 percent of a segment in said direction.

57. The heating weave of claim 54, wherein either the first group of threads or the second group of threads comprise electrically conductive threads.

58. The heating weave of claim 57, wherein the electrically conductive strips and the feed strips are perpendicular to the direction of the group of threads that comprises the electrically conductive threads.

59. The heating fabric of claim 58, wherein said first group of threads is interwoven with said second group of threads.

60. A product comprising the heating fabric of claim 54.

61. In an electrical heating fabric, an arrangement of electrical feed strips for enabling adjustment to compensate for manufacturing variations in the fabric, the arrangement comprising a plurality of sets of electrical feed strips, wherein at least one of said sets includes at least two electrical feed strips which are substantially parallel and which are separated by a predetermined distance that is substantially less than the distance between said sets.

62. The arrangement of claim 61, wherein at least two of said sets include at least two electrical feed strips which are substantially parallel and which are separated according to predetermined schemes.

63. The arrangement of claim 62, wherein the predetermined scheme of one of said sets features distances that are substantially smaller than the predetermined scheme of another of said sets.

64. The arrangement of claim 61, wherein at least one of said sets includes more than two electrical feed strips which are substantially parallel and which are separated according to a predetermined scheme.
